(19) United States
(12) Patent Application Publication
(10) Pub. No.: US 2009/0138507 A1
(43) Pub. Date: May 28, 2009

(54) AUTOMATED PLAYBACK CONTROL FOR AUDIO DEVICES USING ENVIRONMENTAL CUES AS INDICATORS FOR AUTOMATICALLY PAUSING AUDIO PLAYBACK

(75) Inventors: ERIK J. BURCKART, RALEIGH, NC (US); STEVE R. CAMPBELL, LILLINGTON, NC (US); ANDREW J. IVORY, WAKE FOREST, NC (US); AARON K. SHOOK, RALEIGH, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/945,732

(22) Filed: Nov. 27, 2007

(51) Int. Cl. G06F 12/00; G06F 17/00; G06F 17/30

(52) U.S. Cl. 707/104.1; 700/94; 707/E17.001

(57) ABSTRACT

The present invention discloses a solution for automated playback control for portable audio devices using environmental cues as indicators for interrupting playback. In the solution, an event handler can be responsive to environmental cues around the user of the portable audio device to determine if playback should be interrupted. Triggering events can be speech emanating from the user or another proximate entity, proximity detection of a person or device, user behavior changes/transitions, and the like. Device configuration can allow for user interaction to permit or deny playback interruption. User interactions can range from a “yes/no” speech response to motion sensitive headphones detecting a head “nod” or “shake” gesture to indicate approval or refusal.

### BACKGROUND

1. Field of the Invention

The present invention relates to the field of audio devices and, more particularly, to automated playback control for audio devices using environmental cues as indicators for automatically pausing audio playback.

2. Description of the Related Art

The presence of portable audio devices has grown considerably in the recent past resulting in widespread usage. Users of portable audio devices frequently enter and exit conversations while wearing these devices. In these situations, the user must manually stop/pause playback on the device to pay attention and participate in these conversations. Once the conversation is finished, the wearer will have to manually restart playback on the device. Portable devices are often small enough to fit into the wearer's pocket or attached to the arm with an armband. These locations, while convenient for carrying a device, do not allow quick and easy access to the playback controls. In crowded areas, where the user is likely to enter and leave conversations frequently, this manual control of playback can become a major inconvenience and rapidly become tedious.

Additionally, users may frequently interact with other devices such as answering phone calls on a mobile phone. When attempting to answer an incoming phone call, pausing/stopping playback is typically not a priority as the focus is answering the call. Thus manually controlling playback can become an unwanted hassle to the user. If the user chooses not to pause/stop playback, playback can quickly become a distraction during the phone conversation. What is needed is a means to provide users with an unencumbered approach to controlling playback.

### SUMMARY OF THE INVENTION

The present invention discloses a solution for automated playback control for portable audio devices using environmental cues as indicators for interrupting playback. In the solution, an event handler can be responsive to environmental cues around the user of the portable audio device to determine if playback should be interrupted. Triggering events can be speech emanating from the user or another proximate entity, proximity detection of a person or device, user behavior changes/transitions, and the like. Device configuration can allow for user interaction to permit or deny playback interruption. User interactions can range from a “yes/no” speech response to motion sensitive headphones detecting a head “nod” or “shake” gesture to indicate approval or refusal.

The present invention can be implemented in accordance with numerous aspects consistent with the materials presented herein. One aspect of the present invention can include a method for playing audio that includes automatically detecting an occurrence of an environmental event external to an audio playing device while the audio playing device is playing audio. The audio playback can be automatically paused responsive to the detected occurrence. A different occurrence of another environmental event can be detected. Audio playback can be automatically resumed responsive to the detected different occurrence.

Another aspect of the present invention can include a method for controlling playback in a portable multimedia device. In the method, a pausing event can be triggered in response to at least one pause cue. The pause cue can result from a condition automatically detected by a sensor of the portable multimedia device. At least one of a set of defined actions can be performed based upon the determining step. The defined set of actions can include an action that pauses audio playback. A resuming event can be fired in response to at least one resume cue. The resume cue can result from a condition automatically detected by a sensor of the portable media device. Playback of the paused audio can be resumed in response to an occurrence of the resuming event.

Still another aspect of the present invention can include an audio playing device that includes a playback controller, at least one environment sensor, and an event handler. The playback controller can control a playback of audio from the audio playing device. The playback control can include a pause and a resume capability. The environment sensor(s) can each detect a condition of an external environment about the audio playing device. The event handler can selectively activate/deactivate the pause and the resume capabilities of the playback controller based upon conditions detected by the at least one environment sensor.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a set of scenarios for interacting with a portable audio device able to automatically control playback in accordance with an embodiment of the inventive arrangements disclosed herein.

FIG. 2 is a schematic diagram illustrating a system for a portable audio device capable of interrupting playback based on an occurrence of a detectable event in accordance with an embodiment of the inventive arrangements disclosed herein.

FIG. 3 is a schematic diagram illustrating a method for automatically pausing playback in accordance with an embodiment of the inventive arrangements disclosed herein.

### DETAILED DESCRIPTION OF THE INVENTION

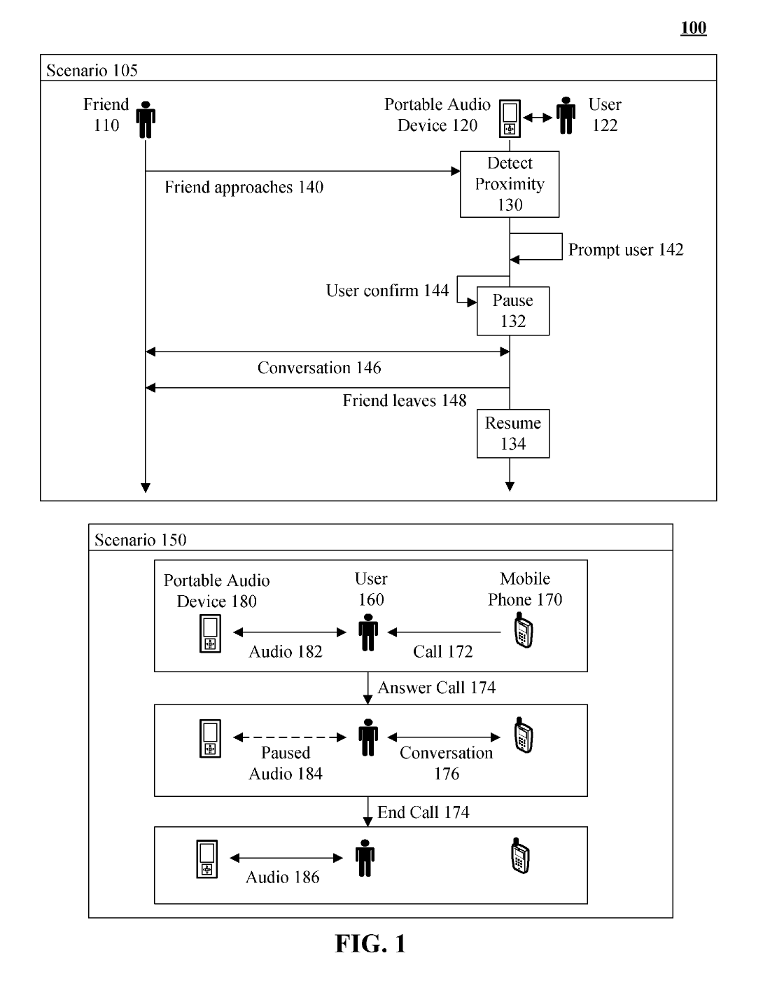

FIG. 1 is a schematic diagram illustrating a set of scenarios 105, 150 for interacting with a portable audio device able to automatically control playback in accordance with an embodiment of the inventive arrangements disclosed herein. In scenarios 105, 150, a portable audio device can interrupt and resume playback based on detected events. Portable audio device 120, 180 can be an MP3 player or similar portable multimedia device. For example, a user listening to music on an audio player can enter and leave conversations without manually pausing/resuming audio playback.

In scenario 105, a portable audio device 120 used by a user 122 can detect a friend's 110 presence, which triggers a pausing event, which can result in interrupting of audio playback. User approaches 140 event can trigger a proximity detection 130 event in audio device 120, which can be determined as a pausing event. In one embodiment, a proximity sensor in device 120 can be used to detect a friend 110 in proximity of user 122. Based on configuration settings of device 120, portable audio device 120 can trigger event prompt user 142. In another embodiment, a “heartbeat sensor” can be utilized to detect the presence of another person in proximity of the user 122. The strength of the heartbeat signal can be used to determine proximity and trigger a prompt user 142 event. Device 120 can present user 122 with an audio cue to indicate an automated pausing event has been triggered. Audio cue can be a voice prompt, user selected sound, audio recording, and the like. For instance, device 120 can play a pre-recorded voice prompt which can ask a question such as “Would you like to pause playback?” Event 142 can cause device 120 to wait for user input to confirm/reject pausing of audio playback before taking action.

User confirmation in event 144 can trigger pause 132 event, causing playback to pause. User confirm 144 event can be detected in a variety of ways. For instance, speech recognition can be used to allow a user 122 to approve/reject playback interruption by replying “yes” or “no”. Alternatively, motion sensitive headphones could be coupled with audio device 120 which can detect head movement. For example, a head “nod” movement can indicate consent where as a head “shake” motion can indicate refusal. Once pause 132 event has occurred, user 122 and friend 110 can participate in conversation 146. At the end of the conversation 146, friend 110 can leave the proximity of user 122. User leaves 148 event can trigger resume 134 event which can automatically continue playback. Distance proximity thresholds for resuming playback can be established by user 122 or automatically determined by device 120. Automatic determination can be based on historical patterns of proximity and/or threshold settings. Additionally, timeout settings can be used to delay resume 134 temporarily under conditions where friend 110 and user 122 proximity can vary briefly.

In scenario 150, portable audio device 180 can automatically interrupt playback when a user 160 uses mobile phone 170. User 160 listening to audio 182 can use mobile phone 170 without manually pausing playback. Device 180 can detect the pausing event of call 172 based on the ring tone emitted by mobile phone 170. Alternatively, answer call 174 event, in addition to placing a call, can also trigger a pausing event. For example, when user 160 picks up call 172, audio device 180 can detect user's 160 speech. Once the pausing event is detected, device 180 can automatically pause playback. In the event audio 182 is non-interruptible (e.g. broadcast radio, streaming audio, etc), device 180 can be configured to mute or stop playback. During conversation 176, device 180 can maintain paused audio 184 state until a resuming event is detected (e.g. end call 174). When end of call 174 occurs, device 180 can detect speech silence and act appropriately. Depending on user configuration of device 180, the user 160 can be prompted by device 180 to determine if playback should resume. User confirm/reject mechanisms can be similar to the methods used in user confirm 144 event in scenario 105. In one embodiment, user 160 can use pre-defined cues that can trigger playback continuation. Cues can include spoken keywords, motion gestures, sounds, and the like. These cues can be configured in device 180 to be recognized and be responded to accordingly.

Scenarios 105 and 150 are intended to be illustrative in nature and not comprehensive. Accordingly, the automatic pausing of audio can be applied in numerous other situations. For example, the audio pausing technique can be applied to a driving context to pause audio, whenever a significant change in acceleration occurs that may indicate a dangerous situation in which audio playback can be distracting. In another situation, help related audio played from a self-service checkout kiosk can be automatically paused whenever a human assistant approaches the kiosk. Generally, audio playback can be automatically paused in any situation, where continued audio playback can be distracting and be considered within the scope of the disclosed invention.

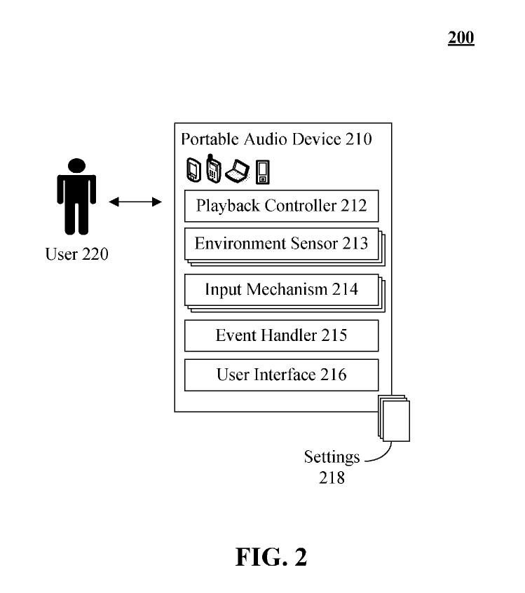

FIG. 2 is a schematic diagram illustrating a system for an audio device capable of interrupting playback based on an occurrence of a detectable event in accordance with an embodiment of the inventive arrangements disclosed herein. In system 200, a playback controller 212 of an audio device 210 can be used to automatically control playback in response to situations the user 220 experiences. For example, an MP3 player (e.g., device 210) can be configured to pause playback when a user 220 begins a conversation with another person. Playback pausing settings 218 and criteria can be configured for the user 220.

The audio device 210 can be a device capable of generating audio. The device 210 can include an audio transducer (e.g., a speaker) capable of playing audio and/or an audio port/interface through which audio from the device 210 can be conveyed to an external speaker or audio system (e.g., headphones, computer speakers, car or home stereo system, etc.) for playback. For example, the audio device 210 can be implemented as a portal music player (e.g., MP3 player), a mobile phone with music playback capabilities, an electronic gaming system, a portable DVD player, a radio, a receiver of a home stereo system, an in-vehicle music system, a personal navigation device, and the like.

Audio device 210 can include a playback controller 212, one or more environment sensors 213, one or more input mechanisms 214, an event handler 215, a user interface 216, and the like. The playback controller 212 can be utilized to control audio playback in response to conditions/events detected by event handler 215. Playback controller 212 can be configured through settings 218 to behave differently based on criteria of conditions or events detected. The settings 218 can be adjusted by using user interface 216. In one embodiment, when playback is paused for an extended period of time, the playback controller 212 can be configured to stop playback entirely and/or to shift device 210 to a power saving state, such as an off state. This can be a setting useful in conserving battery life of device 210. In one embodiment, playback controller 212 can be capable of audio and/or video playback. When audio/video playback is present, controller 212 can be configured to pause audio/video playback. During playback pauses, a screensaver can optionally be presented in video enabled embodiments of device 210.

The environment sensor 213 can detect one or more conditions, which can fire events related to playback (handled by event handler 215. For example, one environment sensor 213 can be a proximity detector configured to detect a presence of a nearby individual. Another sensor 213 can be an accelerometer, which is able to detect a change in motion of the device 210, which can signify the user 220 has paused to talk with a nearby individual or that another situation exists (e.g., a sudden stop while driving) that can selectively trigger playback to be paused. Another sensor 213 can be an audio microphone and related processing mechanism, which detects ambient sounds and/or sound pressure levels. Specific sounds, such as a police siren or an alarm, can be distinguished from other sounds for playback pausing purposes. Sensors 213 for detecting ambient audio can be particularly valuable when the device 210 is used in conjunction with noise cancellation headphones, which can cause user 220 to be ignorant of important environmental conditions.

The input mechanism 214 can be any type of mechanism through which a user 220 can direct actions of the audio device. Input from mechanism 214 can be used to direct the device 210 to resume paused playback, to accept an automatic pause, and to perform other user controllable actions. In one embodiment, input mechanism 214 can include a microphone and a speech recognition component capable of accepting and responding to speech input from user 220. In another embodiment, the input mechanism 214 can be a conveniently placed tactile switch or button that responds to pressure. For example, a palm squeeze actuator or a bump to talk actuator, can be attached to the strap worn about a hand of the user 220 to convey device controlling input to device 210 in an unencumbered (e.g., hands free) fashion. The input mechanism 214 can also include an electromyographic sensor that utilizes skin electrodes to detect specific muscle patterns that user 220 can voluntarily control. For example, an electromyographic sensor can be triggered by user 120 touching a thumb and little finger. The input mechanism is not to be limited to any particular technology and any of a variety of other sensor and switching technologies are contemplated herein. For example, pneumatic, hydraulic, temperature, audio, eye tracking, motion detecting, and combinations thereof are contemplated.

Event handler 215 can be responsible for detecting and performing one or more actions based on a determined event. In one embodiment, event handler 214 can receive input from sensor 213 which can cause events to fire. A manner in which playback controller 212 responds to these events, can depend upon settings 218 and additional user input received through mechanism 214.

Settings 218, configured through user interface 216, can allow a user to select predefined pausing events for event handler 214 to react upon. In one embodiment, different profiles can be established, which have different settings. For example, a gym profile can be associated with one set of playback pause settings, a jogging profile can be associated with another set, a work profile with a third set, and so forth. The settings 218 can vary in complexity and configurability based upon implementation instances, but an arbitrary complexity is contemplated so long as deterministic programmatic decisions are able to be made by device 210 based upon the settings 218. For example, in one implementation, settings 218 can be configured for automatically adapting speech decibel threshold (or general ambient sound pressure level adjustment) values to environments based on ambient noise. Threshold values compared against settings 218 and/or the settings 218 themselves can include fixed and/or dynamically adjusting values.

User interface 216 can include a user input region and an output region. Input region receptive to user input can include tactile buttons, force sensing resistor (FSR), microphone, and the like. These input mechanisms can supplement mechanism 214 and/or be additional mechanisms for interacting with device 210, which would be generally inconvenient for a user 220 to quickly manipulate in a playback pause situation. Output regions can include liquid crystal display (LCD), organic light emitting diode (OLED), touch-screen display, and the like. User interface 216 can include a “lock” feature which can disable accidental user input. In one embodiment, a lock feature can be enabled or disabled via a slider switch configurable via interface 216. Event handler 216 can be configured to ignore pausing/resuming events when the lock feature is enabled.

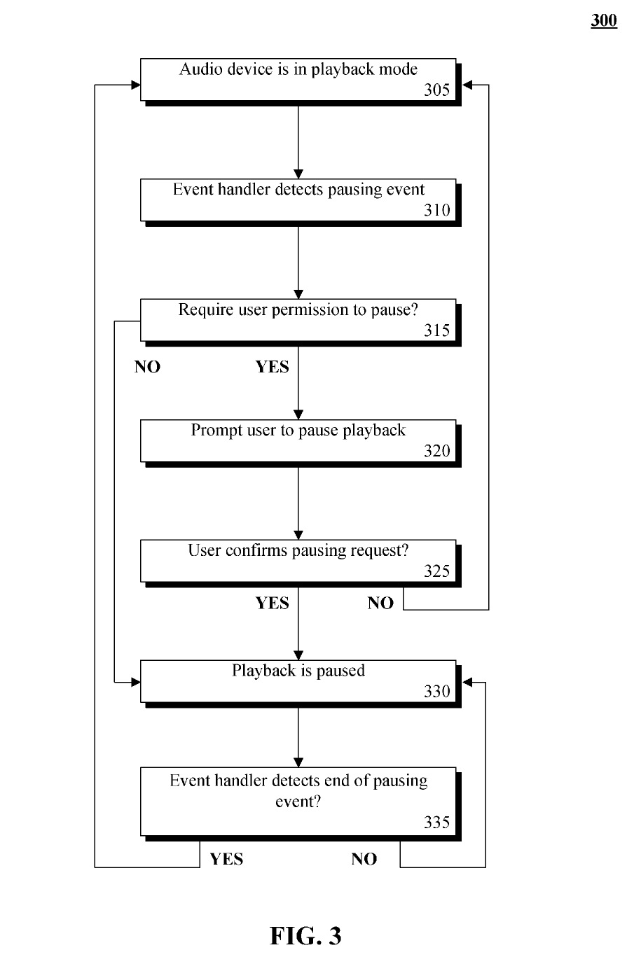

FIG. 3 is a schematic diagram illustrating a method 300 for automatically pausing playback in accordance with an embodiment of the inventive arrangements disclosed herein. Method 300 can be performed in the context of system 200. In method 300, an audio device being used by a user can automatically pause playback upon determining a pausing event. In step 305, an audio device in playback mode can be responsive to pausing events. In step 310, the event handler can detect a pausing event has occurred. Pausing events can include user speech, speech detected in proximity of the user, presence detection of a person or entity, and the like. Additional conditions for determining a pausing event can be contemplated based on the functionality present in the audio device. In step 315, if the device is configured to require user permissions to pause, the method can continue to step 320, else proceed to step 330. In step 320, the audio device can prompt for user approval to pause playback. Timeout threshold settings for user responses can be established which can allow the user to disregard prompts to ignore the pausing event. When a user ignores user prompts, event handler can abandon the pausing event and playback can continue without interruption.

In step 325, if the user confirms the pausing request, the method can continue to step 330, else return to step 305. In step 330, playback on the audio device is paused. Playback can resume based on user interaction or be automated by the event handler. In step 335, if the event handler detects an end of pausing event, the method can return to step 305, else return to step 330.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for playing audio comprising:
automatically detecting an occurrence of an environmental event external to an audio playing device while the audio playing device is playing audio; and
automatically pausing audio playback responsive to the detected occurrence.

2. The method of claim 1, further comprising:
automatically detecting a different occurrence of an environmental event external to audio playing device, which was automatically paused by the pausing step; and
automatically resuming audio playback responsive to the detected different occurrence.

3. The method of claim 2, wherein said steps of claims 1 and 2 are performed automatically by said audio playing device in accordance with a set of instructions stored within components of the audio playing device and executed by the audio playing device, wherein said set of instructions are contained within at least one of software, firmware, and hardware electronics of the audio playing device.

4. The method of claim 3, wherein said audio playing device is a portable music playing device.

5. The method of claim 1, wherein said detected occurrence is a change of ambient noise of an audio environment proximate to the audio playing device.

6. The method of claim 1, wherein said detected occurrence comprises an approach of a person to a region proximate to the audio playing device.

7. The method of claim 2, wherein said audio playing device is a mobile communication device, and wherein said detected occurrence comprises an initiation of a communication session, and wherein the different occurrence comprises a termination of the communication session.

8. The method of claim 2, wherein said audio playing device is an audio and video playing device, and wherein said pausing and resuming of audio playback also pauses and resumes video playback.

9. A method for controlling playback in a portable multimedia device comprising:
triggering a pausing event in response to at least one pause cue, wherein said pause cue results from a condition automatically detected by a sensor of the portable multimedia device;
performing at least one of a set of defined actions based upon the determining step, wherein the at least one defined action comprises a pausing of audio playback;
firing a resuming event in response to at least one resume cue, wherein said resume cue results from a condition automatically detected by a sensor of the portable media device; and
resuming playback of said paused audio in response to an occurrence of the resuming event, wherein the triggering, performing, firing, and resuming steps are steps performed in accordance with a set of instructions contained within the portable media device, wherein said set of instructions are contained within at least one of software, firmware, and hardware electronics of the audio playing device.

10. The method of claim 9, wherein said sensor associated with the pause cue condition and said sensor associated with said resume cue are each selected from a group of sensors comprising: a microphone, an accelerometer, a motion detector, a presence detection device, and a heartbeat sensor.

11. The method of claim 9, wherein one of said set of defined actions is a prompt for user input to confirm or reject a pausing of audio playback.

12. An audio playing device comprising:
a playback controller configured to control a playback of audio from the audio playing device, wherein said playback control comprises a pause and a resume capability;
at least one environment sensor configured to detect a condition of an external environment about the audio playing device; and
an event handler configured to selectively activate/deactivate the pause and the resume capabilities of the playback controller based upon conditions detected by the at least one environment sensor.

13. The audio playing device of claim 12, further comprising:
a memory containing a plurality of user configurable settings, wherein said settings establish a set of conditions for the event handler to selectively activate/deactivate the pause and the resume capabilities.

14. The audio playing device of claim 12, further comprising:
at least one hands-free input mechanism for a user to provide input, which is translated into a set of commands to be sent to the playback controller, wherein one of the commands activates the pause capability and wherein another one of the commands activates the resume capability, wherein said provided input is accepted in response to a device issued prompt relating to at least one of the pause and the resume capabilities.

15. The audio playing device of claim 12, wherein said at least one environment sensor comprises a presence detector configured to determine a proximity of at least one individual to the audio playing device, wherein changes in the proximity trigger events handled by the event handler that affect the pause and resume capabilities.

16. The audio playing device of claim 12, wherein said at least one environment sensor comprises at least one of a sound pressure level meter and a microphone, said sensor being configured to determine a level of ambient noise about the audio playing device, wherein changes in the ambient noise level trigger events handled by the event handler that affect the pause and resume capabilities.

17. The audio playing device of claim 12, wherein said at least one environment sensor comprises an accelerometer, wherein changes detected by the accelerometer trigger events handled by the event handler that affect the pause and resume capabilities.

18. The audio playing device of claim 12, wherein said audio playing device is a portable music playing device.

19. The audio playing device of claim 18, wherein said music playing device plays digital music stored upon a memory of the music playing device, wherein said format of the digital music that the audio playing device is configured to play comprises a perceptual codex.

20. The music playing device of claim 12, wherein said audio playing device is configured to play video, wherein said playback controller is configured to pause and resume video playback when audio playback is paused and resumed.
